(19) United States
(12) Patent Application Publication
(10) Pub. No.: US 2026/0024433 A1
(43) Pub. Date: Jan. 22, 2026

(54) ENERGY HARVESTING REMOTE SENSOR TELEMETRY SYSTEM AND METHODS FOR USAGE THEROF

(71) Applicant: Kidde Technologies Inc., Wilson, NC (US)

(72) Inventors: Len Seebaluck, Wake Forest, NC (US); Aaron Rogers, Surf City, NC (US)

(21) Appl. No.: 18/780,035

(22) Filed: Jul. 22, 2024

(51) Int. Cl. G08C 17/02; G01D 11/00; H02N 1/04; H02N 2/18

(52) U.S. Cl. CPC G08C 17/02; G01D 11/00; H02N 1/04; H02N 2/186

(57) ABSTRACT

A wireless sensor system for a vehicle includes a controller, a wireless transmitter in electronic communication with the controller, a sensor, and a generator device. The generator device includes a wireless receiver in wireless communication with the wireless transmitter. The generator device further includes an electric-to-mechanical transducer in electronic communication with the wireless receiver and a piezoelectric or triboelectric generator proximate to or in contact with the electric-to-mechanical transducer. The generator device further includes an energy-storage device. The energy storage device includes an input in electronic communication with the piezoelectric or triboelectric generator, and an output in electronic communication with the sensor.

### BACKGROUND

The present invention relates generally to aircraft sensors. Modern aircraft include many sensors distributed throughout the aircraft. Many of these sensors are installed in the extremities of the aircraft. These sensors include cargo smoke detectors, bleed leak sensors, fire extinguisher health monitors, temperature sensors, and more. Traditionally, these sensors are hardwired systems. Hardwiring sensors can ensure that the remote sensors are powered and can ensure that the signal integrity is not compromised. However, the wires used in these traditional sensor systems results in significant weight, which reduces fuel economy of the aircraft. Furthermore, signals sent through wires can become compromised due to wire fatigue, electromagnetic coupling, and more.

### SUMMARY

In one example of the disclosure, a wireless sensor system for a vehicle includes a controller, a wireless transmitter in electronic communication with the controller, a sensor, and a generator device. The generator device includes a wireless receiver in wireless communication with the wireless transmitter. The generator device further includes an electric-to-mechanical transducer in electronic communication with the wireless receiver and a piezoelectric or triboelectric generator proximate to or in contact with the electric-to-mechanical transducer. The generator device further includes an energy-storage device. The energy storage device includes an input in electronic communication with the piezoelectric or triboelectric generator, and an output in electronic communication with the sensor.

In another example of the disclosure, a method is disclosed for operating a sensor connected to a vehicle. The method includes transmitting via a wireless transmitter, in electronic communication with a controller, a wireless charging signal to a wireless receiver of a generating device. An electric-to-mechanical transducer transduces the wireless charging signal to vibrations. A piezoelectric or triboelectric generator transforms the vibrations into a voltage output. The voltage output of the piezoelectric or triboelectric generator charges a capacitor that is electronically connected to the sensor.

In another example of the disclosure, a generator device for charging a sensor includes a wireless receiver and an electric-to-mechanical transducer in electronic communication with the wireless receiver. A piezoelectric or triboelectric generator is proximate to or in contact with the electric-to-mechanical transducer. An energy-storage device is in electronic communication with the piezoelectric or triboelectric generator. The generator device also includes a node with an inlet in electronic communication with the energy-storage device.

### BRIEF DESCRIPTION OF THE DRAWINGS

FIG. 1 is a schematic diagram of a wireless sensor system for a vehicle that includes a controller, a wireless communication device, a bleed air duct, a sensor, and a generation device.

FIG. 2 is a schematic diagram of the embodiment of the invention shown in FIG. 1, but without the bleed air duct and with detail directed to the generation device

FIG. 3 is a flowchart depicting a method for powering the sensor using a wireless transmitter of the wireless communication device.

FIG. 4 is a flowchart depicting a method for powering the sensor using aircraft movement.

FIG. 5 is a flowchart depicting a method for transforming the wireless signal into a voltage output.

### DETAILED DESCRIPTION

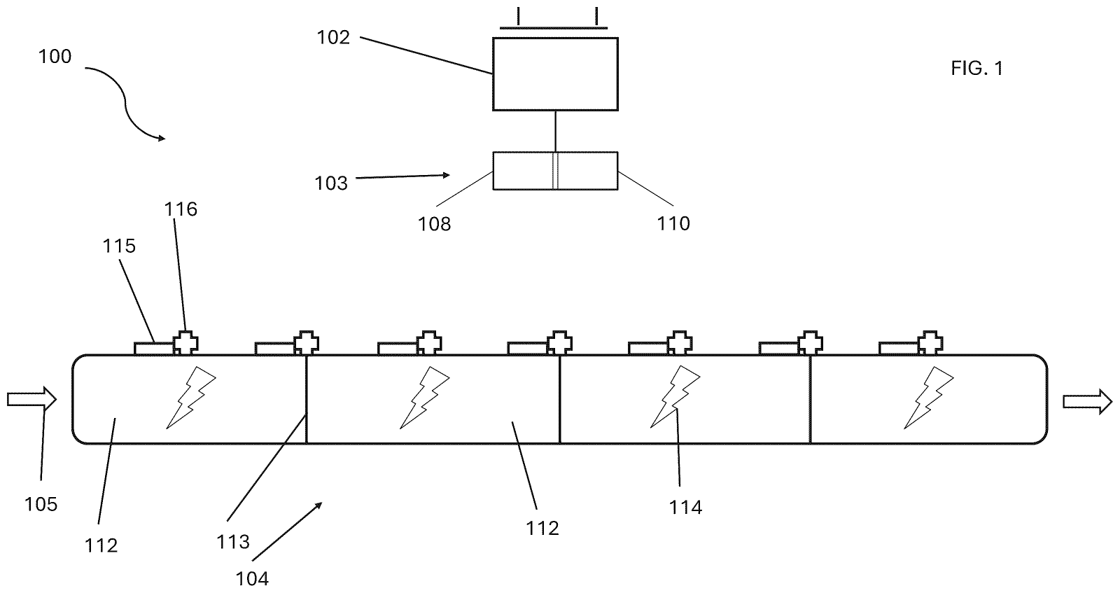

FIG. 1 schematically illustrates wireless sensor system 100 which is an energy harvesting remote sensor telemetry system. Wireless sensor system 100 includes controller 102, wireless communication device 103, and bleed air duct system 104. Wireless communication device 103 comprises wireless transmitter 108 and wireless receiver 110. Bleed air duct system 104 comprises bleed air 105, a plurality of bleed air duct segments 112, pipe junctions 113, aircraft movement 114, generation device 115, and sensor 116. Bleed air duct system 104 is only an example of an application for wireless sensor system 100. In other examples, aircraft movement 114 may be any movement or vibration sufficient to power sensor 116. One skilled in the art can adapt the disclosure to a variety of applications without undue experimentation, including but not limited to air conditioning pack compartment temperature monitoring, inert gas generator compartment temperature monitoring, and anti-ice sensors.

Controller 102 is mounted within an aircraft (not shown). Controller 102 is electronically wired to wireless communication device 103 such that controller 102 can send signals wirelessly through wireless transmitter 108 and receive signals through wireless receiver 110. The plurality of bleed air duct segments 112 are connected to each other by pipe junctions 113 to form bleed air duct system 104. Controller 102 can be positioned within a cabin of the aircraft while bleed air duct system 104 is relatively remote from controller 102. In one example of wireless sensor system 100, sensor 116 is mounted on one of pipe junctions 113. In another example of wireless sensor system 100, sensor 116 is located at a junction of two or more of the plurality of bleed air ducts 112. Generator device 115 is mounted on one of the plurality of bleed air ducts 112 and connects to sensor 116. Generator device 115 is in electronic and informational communication with sensor 116.

During an active period, aircraft movement 114 is created and propagates throughout bleed air duct system 104. The active period can include, but is not limited to, takeoff, flight, and landing. During an inactive period, aircraft movement 114 is not created or is lessened. The inactive period can include parking and other ground operations. Aircraft movement 114 can be created by vibration of bleed air duct system 104 caused by movement of bleed air 105 through bleed air duct system 104, or by vibrations of bleed air duct system 104 caused by movement of an adjacent aircraft engine.

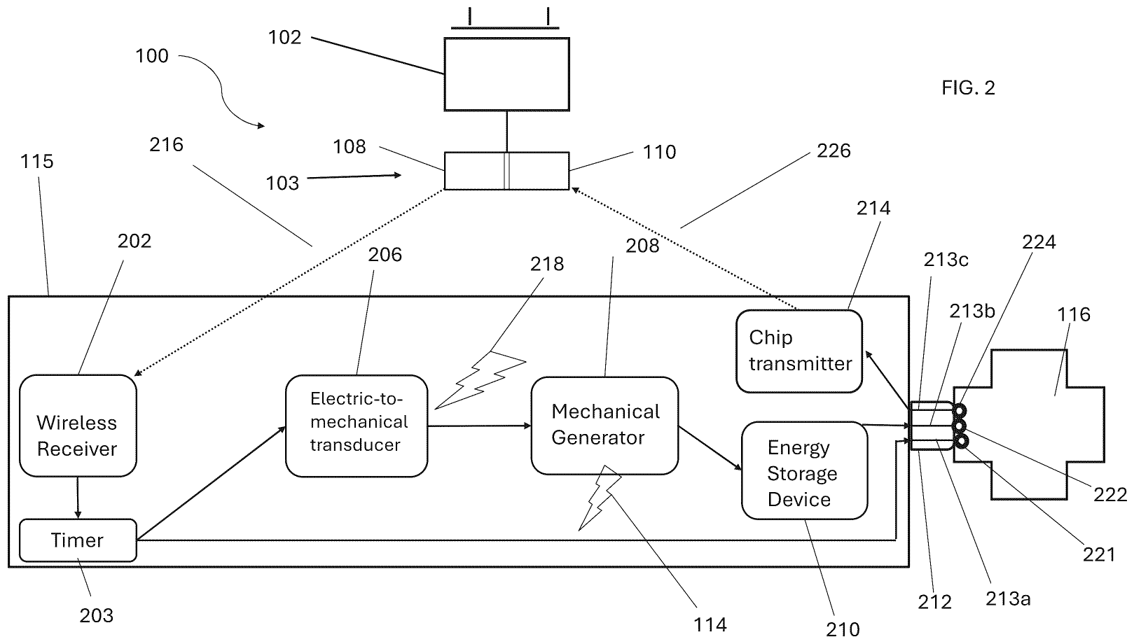

As discussed below with reference to FIG. 2, during the active period, aircraft movement 114 can be sufficient to power generator device 115 through piezoelectric or triboelectric means. During the inactive period, aircraft movement 114 can be insufficient to power generator device 115 through piezoelectric or triboelectric means. Controller 102 can provide power wirelessly to generator device 115 and sensor 116 during the inactive period. Wireless sensor system 100 advantageously uses super capacitors that allows sensor 116 to be powered without local batteries for energy storage.

FIG. 2 is a schematic view of wireless sensor system 100, with particular attention to generator device 115 and without plurality of air duct segments 112 and pipe junctions 113. Wireless sensor system 100 includes controller 102, wireless communication device 103, generator device 115, and sensor 116. Generator device 115 comprises wireless receiver 202, timer 203, electric-to-mechanical transducer 206, mechanical generator 208, energy storage device 210, node 212, and chip transmitter 214. Energy storage device 210 comprises a storage input and a storage output. Node 212 comprises information inlet 213a, power inlet 213b, and information outlet 213c. Sensor 116 comprises information input 221, power input 222, and information output 224. First wireless signal 216 is transmitted from wireless transmitter 108 to receiver 202. Second wireless signal 226 is transmitted from chip transmitter 214 to wireless receiver 110. Generated vibration 218 is created by piezoelectric transducer 206. Mechanical generator 218 receives aircraft movement 114.

Wireless transmitter 108 of wireless communication device 103 is remote from generator device 115 and is wirelessly connected to wireless receiver 202 of generator device 115. Wireless receiver 202 is electronically connected to timer 203. Timer 203 is electronically connected to electric-to-mechanical transducer 206 and is electronically connected to information inlet 213a of node 212. Timer 203 can be a timed electrical switch that alternates connectivity between electric-to-mechanical transducer 206 and information inlet 213a of node 212. Information inlet 213a is electronically connected to information input 221 of sensor 116. Electric-to-mechanical transducer 206 can be proximate to or in contact with the mechanical generator 208 such that electric-to-mechanical transducer 206 can vibrate mechanical generator 208 when electric-to-mechanical transducer 206 vibrates. Mechanical generator 208 is electronically connected to the storage input of energy storage device 210. The storage input is electronically connected to energy storage device 210. The storage output of energy storage device 210 is electronically connected to power inlet 213b of node 212. Power inlet 213b of node 212 is electronically connected to power input 222 of sensor 116. Information outlet 224 of sensor 116 is electronically connected to information outlet 213c of node 212. Information outlet 213c is electronically connected to chip transmitter 214. Chip transmitter 214 is wirelessly connected to wireless receiver 110 of wireless communication device 103. In one example, node 212 is a component of generator device 215 and is connected to sensor 116. In another example, node 212 is a component of sensor 116 and is connected to generator device 215. Node 212 can be an electrical port that releasably connects generator device 215 to sensor 116. In another example, node 212 can be a permanent electrical connection between generator device 215 and sensor 116 that transfers information and power between generator device 215 and sensor 116.

First wireless signal 216 is created by controller 102 and is transmitted by wireless transmitter 108. In one example, first wireless signal 216 carries an information payload. Alternatively, first wireless signal 216 carries a power signal with an electromagnetic field that interacts with wireless receiver 202 of generator device 115 to generate an electrical voltage that powers electric-to-mechanical transducer 206. In one example, controller 102 alternates between carrying the information payload and the power signal on a timed interval. First wireless signal 216 can comprise a frequency-hopping spread spectrum signal and wireless transmitter 108 can comprise a frequency-hopping spread spectrum transmitter. If first wireless signal 216 comprises a frequency-hopping spread spectrum signal, first wireless signal 216 is transmitted at different frequencies with multiple carrier signals. In this example, wireless receiver 202 can comprise a frequency-hopping spread spectrum receiver that can sync with the carrier signal that is strongest. Advantages to first wireless signal 216 comprising a frequency-hopping spread spectrum signal include robust communication with wireless receiver 202, immunity to electromagnetic interference (EMI) and noise, and an ability to transmit through multiple different physical transmission barriers such as metal or fuel.

Wireless receiver 202 receives first wireless signal 216 and converts first wireless signal 216 into a first electric signal. The first electric signal has a first voltage and a first current. In one example, the first electric signal is sent from wireless receiver 202 to timer 203. In one example, timer 203 is configured to alternate between transmitting the first electric signal to electric-to-mechanical transducer 206 and transmitting the information payload of first wireless signal 216 to information inlet 213a on the timed interval.

In the example of FIG. 2, electric-to-mechanical transducer 206 can be a piezoelectric transducer. Electric-to-mechanical transducer 206 converts the first electric signal into generated vibrations 218. Generated vibration 218 is then carried to mechanical generator 208 via a medium that physically contacts both electric-to-mechanical transducer 206 and mechanical generator 208. The medium can be a solid, a gas, or a liquid that contacts both electric-to-mechanical transducer 206 and mechanical generator 208 and that transfers vibrational energy from electric-to-mechanical transducer 206 to mechanical generator 208. In the example of FIG. 2, mechanical generator 208 can be a piezoelectric generator or a triboelectric generator. In one example, electric-to-mechanical transducer 206 and mechanical generator 208 reside within a chamber filled by a gaseous medium, and electric-to-mechanical transducer 206 includes a piezoelectric element that converts the electrical energy from the first electrical signal into generated vibrations 218 that energize the gaseous medium. In this example, mechanical generator 208 includes a second piezoelectric element that is vibrated by the energized gaseous medium to generate a voltage output from mechanical generator 208 with a second voltage and a second current. In another example, electric-to-mechanical transducer 206 and mechanical generator 208 can abut each other directly, such that electric-to-mechanical transducer 206 can vibrate mechanical generator 208 directly when electric-to-mechanical transducer 206 is energized by the first electrical signal. In other examples, electric-to-mechanical transducer 206 and/or mechanical generator 208 can include a triboelectric generator. Mechanical generator 208 can also be vibrated by aircraft movement 114 (shown in FIG. 1).

Mechanical generator 208 receives generated vibration 218 and aircraft movement 114 and converts one or both of generated vibration 218 and aircraft movement 114 to the voltage output with the second voltage and the second current. The second voltage of the voltage output is lower than the first voltage of the first electric signal from receiver 202, and the second current of the voltage output is higher than the first current of the first electric signal. The second voltage of the voltage output is approximately suitable for charging energy storage device 210 and powering sensor 116. Energy storage device 210 receives the voltage output and is charged over time by mechanical generator 208. Energy storage device 210 can be a capacitor. In some examples, energy storage device 210 can be a supercapacitor.

Once sufficiently charged and when needed, energy storage device 210 discharges and creates the voltage output needed to power sensor 116. In one embodiment, sensor 116 can further comprise a switch electrically between energy storage device 210 and sensor 116 to control discharge of energy storage device 210 to sensor 116. The payload of the first wireless signal can comprise a request, wherein the request can be to open the switch or to close the switch. In another embodiment, sensor 116 further comprises an internal timer that is configured to close the switch on a set interval. When the circuit is closed, the voltage output is released. The voltage output is received by power inlet 213b of node 212 and powers sensor 116. Sensor 116 can then take a measurement and convey data of the measurement for transmission to controller 102. In one example, the measurement is sent to information outlet 213b of node 212 and information outlet 213b sends a second electric signal, which carries a second information payload representative of the data from sensor 116, to chip transmitter 214. In another example, chip transmitter 214 is a member of sensor 116.

Chip transmitter 214 then converts the second electric signal into second wireless signal 226. In one embodiment, second wireless signal 226 comprises a second frequency-hopping spread spectrum signal and chip transmitter 214 comprises a second frequency-hopping spread spectrum transmitter. If second wireless signal 226 comprises the second frequency-hopping spread spectrum signal, second wireless signal 226 is transmitted at different frequencies with multiple carrier signals. In this example, wireless receiver 110 can comprise a frequency-hopping spread spectrum receiver that can sync with the carrier signal that is strongest. Second wireless signal 226 can carry the second payload. Advantages to second wireless signal 226 comprising a frequency-hopping spread spectrum signal include robust communication, immunity to EMI and noise, and an ability to transmit through multiple different physical transmission barriers such as metal or fuel. Wireless receiver 110 receives second wireless signal 226 and sends the second information payload to controller 102 for processing.

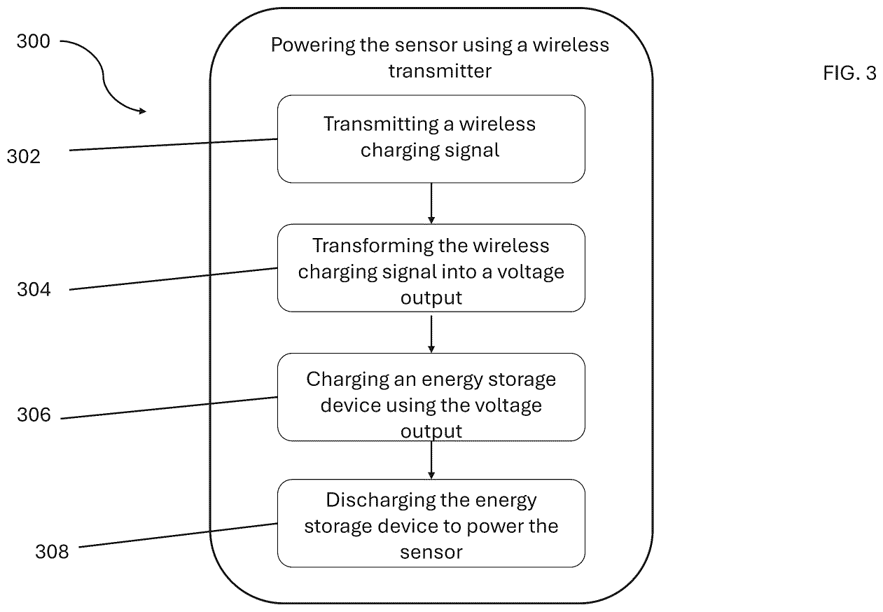

FIG. 3 is a flowchart for a method 300 for powering sensor 116 using wireless communication device 103 and generation device 115. The method 300 comprises first step 302, second step 304, third step 306, and fourth step 308. First step 302 comprises transmitting first wireless signal 216 to receiver 202 via wireless transmitter 108. First step 302 can further comprise encoding the payload into first wireless signal 216. First step 302 can further comprise converting first wireless signal 216 to the frequency-hopping spread spectrum signal.

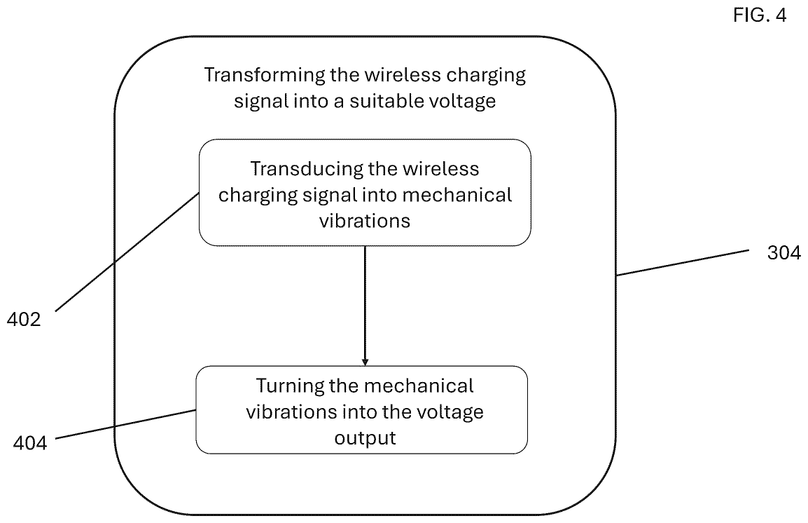

Second step 304 comprises transforming first wireless signal 216 into the voltage output and is shown in greater detail in FIG. 4. Third step 306 comprises charging energy storage device 210 using the voltage output. Finally, fourth step 308 comprises discharging energy storage device 210 to power sensor 116. Fourth step 308 can further comprise closing the circuit in sensor 116, which can be in response to the payload of the first wireless signal commanding closure of the circuit, or can be in response to the internal timer of sensor 116. Fourth step 308 can further comprise sending the first electrical signal to the information input 221 of sensor 116, wherein first electrical signal carries the first payload instructing sensor 116 to close the circuit.

FIG. 4 is a flowchart for the second step 304 comprising first sub-step 402 and second sub-step 404. First sub-step 402 comprises transducing the first electric signal into mechanical energy. First sub-step 402 is accomplished using the first electrical signal from wireless receiver 202 to energize electric-to-mechanical transducer 206 to produce mechanical vibrations. First sub-step 402 can further comprise electric-to-mechanical transducer 206 vibrating the medium via the piezoelectric transducer.

Second sub-step 404 comprises transforming, by mechanical generator 208, the mechanical energy generated by electric-to-mechanical transducer 206 into the voltage output. Second sub-step 404 can further comprise the medium transferring vibrational energy from electric-to-mechanical transducer 206 to mechanical generator 208. As discussed above, mechanical generator 208 can include a piezoelectric element that is deflected and vibrated by the energy imparted into the medium from electric-to-mechanical transducer 206. As the piezoelectric element of mechanical generator 208 deflects and vibrates, the piezoelectric element of mechanical generator 208 generates the voltage output (which includes the second voltage and the second current described above with reference to FIG. 2). Alternatively, mechanical generator 208 can include a triboelectric generator that generates the voltage output through friction with the medium and/or through direct friction with electric-to-mechanical transducer 206.

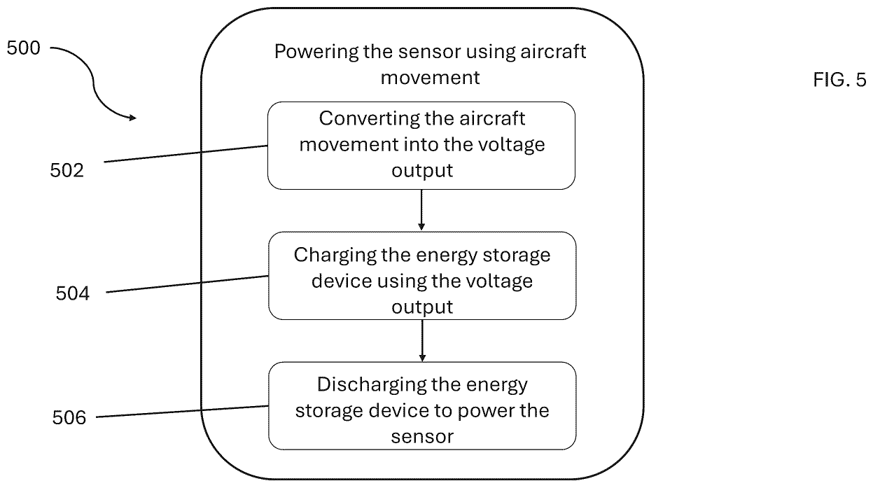

Performing second step 304 according to FIG. 4 has many advantages. For example, second step 304 can generate the second voltage and the second current that is more suitable for charging energy storage device 210 than the first voltage and the first current. The second step 304, in combination with the other steps of method 300, also produces the second voltage and the second current while the aircraft is in the inactive period (described above with reference to FIG. 1), enabling energy storage device 210 to be charged by mechanical generator 208 even when there is no movement from the aircraft. Mechanical generator 208, as a piezoelectric generator, serves two functions. A first function is converting mechanical vibrations from electric-to-mechanical transducer 218 to the voltage output. A second function is converting aircraft movement 118 into the voltage output, as discussed below with reference to FIG. 5. Performing the first function and the second function via a single element saves space and weight, which can result in greater efficiency of the aircraft.

FIG. 5 is a flowchart for method 500 for powering sensor 116 using aircraft movement 114 and generation device 115. Method 500 can be performed in addition to method 300. In one embodiment, method 300 and method 500 are performed simultaneously to provide power redundancy and to simplify powering sensor 116. Method 500 comprises fifth step 502, sixth step 504, and seventh step 506.

Fifth step 502 comprises converting aircraft movement 114 to the voltage output using mechanical generator 208. Sixth step 504 comprises charging energy storage device 210 using the voltage output from mechanical generator 208. Seventh step 506 comprises powering sensor 116 by discharging energy storage device 210 using the voltage output. Seventh step 506 can further comprise closing the circuit in sensor 116, which can be in response to the request of the payload of the first wireless signal, or can be in response to the internal timer of sensor 116.

### DISCUSSION OF POSSIBLE EMBODIMENTS

The following are non-exclusive descriptions of possible embodiments of the present invention.

A wireless sensor system for a vehicle includes a controller, a wireless transmitter in electronic communication with the controller, a sensor, and a generator device. The generator device includes a wireless receiver in wireless communication with the wireless transmitter. The generator device further includes an electric-to-mechanical transducer in electronic communication with the wireless receiver and a piezoelectric or triboelectric generator proximate to or in contact with the electric-to-mechanical transducer. The generator device further includes an energy-storage device. The energy storage device includes an input in electronic communication with the piezoelectric or triboelectric generator, and an output in electronic communication with the sensor.

The wireless sensor system of the preceding paragraph can optionally include, additionally and/or alternatively, any one or more of the following features, configurations and/or additional components in the paragraphs below.

In an embodiment of the foregoing wireless sensor system, the energy-storage device is a capacitor.

In an embodiment of the foregoing wireless sensor system, the wireless sensor system further comprises: a wireless communication device comprising: the wireless transmitter; and a second wireless receiver, and wherein the wireless communication device is in electronic communication with the controller; and the generator device further comprises a second wireless transmitter in electronic communication with the sensor and in wireless communication with the second wireless receiver.

In an embodiment of the foregoing wireless sensor system, the wireless sensor system further comprises a node comprising: an inlet in electronic communication with the output of the energy-storage device and in electronic communication with a power input of the sensor; and an outlet in electronic communication with a data output of the sensor and in electronic communication with the second wireless transmitter.

In an embodiment of the foregoing wireless sensor system, the wireless sensor system further comprises a timer electronically connecting the wireless receiver to the electric-to-mechanical transducer.

In an embodiment of the foregoing wireless sensor system, the sensor further comprises an information input; the node further comprises an information inlet in electronic communication with the wireless receiver and in electronic communication with the information input of the sensor; and the timer electronically connects the wireless receiver to the information inlet of the node.

In an embodiment of the foregoing wireless sensor system, the wireless sensor system further comprises a bleed air duct, the bleed air duct comprising a plurality of duct segments that are connected via a plurality of duct junctions; and the sensor is located at one of the plurality of duct junctions.

In an embodiment of the foregoing wireless sensor system, the generator device is located at the bleed air duct, and wherein the generator device is powered via movement of the bleed air duct.

In an embodiment of the foregoing wireless sensor system, the node releasably connects the generator device to the sensor.

In another example of the disclosure, a method is disclosed for operating a sensor connected to a vehicle. The method includes transmitting via a wireless transmitter, in electronic communication with a controller, a wireless charging signal to a wireless receiver of a generating device. An electric-to-mechanical transducer transduces the wireless charging signal to vibrations. A piezoelectric or triboelectric generator transforms the vibrations into a voltage output. The voltage output of the piezoelectric or triboelectric generator charges a capacitor that is electronically connected to the sensor.

The method of the preceding paragraph can optionally include, additionally and/or alternatively, any one or more of the following features, configurations and/or additional components in the paragraphs below.

In an embodiment of the foregoing method, the method further comprises: converting, by the piezoelectric or triboelectric generator, a movement of the vehicle into the voltage output of the piezoelectric or triboelectric generator; charging the capacitor using the voltage output; and discharging the capacitor to power the sensor.

In an embodiment of the foregoing method, the method further comprises sending, by a second wireless transmitter in electronic communication with the sensor, a second signal containing an information payload from the sensor to a second wireless receiver connected to the controller.

In an embodiment of the foregoing method, the second signal is a frequency-hopping spread spectrum signal, and wherein the wireless charging signal is a frequency-hopping spread spectrum signal.

In an embodiment of the foregoing method, the wireless charging signal carries a second information payload.

In an embodiment of the foregoing method, the method further comprises alternating, by a timer, transmission of the second information payload to the sensor and transmission of the wireless charging signal to the electric-to-mechanical transducer.

In another example of the disclosure, a generator device for charging a sensor includes a wireless receiver and an electric-to-mechanical transducer in electronic communication with the wireless receiver. A piezoelectric or triboelectric generator is proximate to or in contact with the electric-to-mechanical transducer. An energy-storage device is in electronic communication with the piezoelectric or triboelectric generator. The generator device also includes a node with an inlet in electronic communication with the energy-storage device.

The generator device of the preceding paragraph can optionally include, additionally and/or alternatively, any one or more of the following features, configurations and/or additional components in the paragraphs below.

In an embodiment of the foregoing generator device, the generator device further comprises a timer electronically connecting the wireless receiver to the electric-to-mechanical transducer.

In an embodiment of the foregoing generator device, the node further comprises an information inlet in electronic communication with the wireless receiver; and wherein the timer electronically connects the information inlet of the node to the wireless receiver.

In an embodiment of the foregoing generator device, the generator device further comprises a transmitter in electronic communication with an outlet of the node.

In an embodiment of the foregoing generator device, the transmitter is a frequency-hopping spread spectrum transmitter, and wherein the wireless receiver is a frequency-hopping spread spectrum receiver.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A wireless sensor system for a vehicle, comprising:
a controller;
a wireless transmitter in electronic communication with the controller;
a sensor; and
a generator device comprising:
a wireless receiver in wireless communication with the wireless transmitter;
an electric-to-mechanical transducer in electronic communication with the wireless receiver;
a piezoelectric or triboelectric generator proximate to or in contact with the electric-to-mechanical transducer; and
an energy-storage device comprising:
an input in electronic communication with the piezoelectric or triboelectric generator; and
an output in electronic communication with the sensor.

2. The wireless sensor system of claim 1, wherein the energy-storage device is a capacitor.

3. The wireless sensor system of claim 2, further comprising:
a wireless communication device comprising:
the wireless transmitter; and
a second wireless receiver, and
wherein the wireless communication device is in electronic communication with the controller; and
the generator device further comprises a second wireless transmitter in electronic communication with the sensor and in wireless communication with the second wireless receiver.

4. The wireless sensor system of claim 3, and further comprising:
a node comprising:
an inlet in electronic communication with the output of the energy-storage device and in electronic communication with a power input of the sensor; and
an outlet in electronic communication with a data output of the sensor and in electronic communication with the second wireless transmitter.

5. The wireless sensor system of claim 4, and further comprising a timer electronically connecting the wireless receiver to the electric-to-mechanical transducer.

6. The wireless sensor system of claim 5, wherein:
the sensor further comprises an information input;
the node further comprises an information inlet in electronic communication with the wireless receiver and in electronic communication with the information input of the sensor; and
the timer electronically connects the wireless receiver to the information inlet of the node.

7. The wireless sensor system of claim 1, wherein:
the wireless sensor system further comprises a bleed air duct, the bleed air duct comprising a plurality of duct segments that are connected via a plurality of duct junctions; and
the sensor is located at one of the plurality of duct junctions.

8. The wireless sensor system of claim 7, wherein the generator device is located at the bleed air duct, and wherein the generator device is powered via movement of the bleed air duct.

9. The wireless sensor system of claim 6, wherein:
the node releasably connects the generator device to the sensor.

10. A method for operating a sensor connected to a vehicle, comprising:
transmitting via a wireless transmitter, in electronic communication with a controller, a wireless charging signal to a wireless receiver of a generating device;
transducing, by an electric-to-mechanical transducer, the wireless charging signal to vibrations;
transforming, by a piezoelectric or triboelectric generator, the vibrations into a voltage output; and
charging a capacitor with the voltage output of the piezoelectric or triboelectric generator, wherein the capacitor is electronically connected to the sensor.

11. The method for operating a sensor of claim 10, and further comprising:
converting, by the piezoelectric or triboelectric generator, a movement of the vehicle into the voltage output of the piezoelectric or triboelectric generator;
charging the capacitor using the voltage output; and
discharging the capacitor to power the sensor.

12. The method for operating a sensor of claim 11, and further comprising:
sending, by a second wireless transmitter in electronic communication with the sensor, a second signal containing an information payload from the sensor to a second wireless receiver connected to the controller.

13. The method for operating a sensor of claim 12, wherein the second signal is a frequency-hopping spread spectrum signal, and wherein the wireless charging signal is a frequency-hopping spread spectrum signal.

14. The method for operating a sensor of claim 12, wherein the wireless charging signal carries a second information payload.

15. The method for operating a sensor of claim 14, and further comprising:
alternating, by a timer, transmission of the second information payload to the sensor and transmission of the wireless charging signal to the electric-to-mechanical transducer.

16. A generator device for charging a sensor, comprising:
a wireless receiver;
an electric-to-mechanical transducer in electronic communication with the wireless receiver;
a piezoelectric or triboelectric generator proximate to or in contact with the electric-to-mechanical transducer;
an energy-storage device in electronic communication with the piezoelectric or triboelectric generator; and
a node comprising an inlet in electronic communication with the energy-storage device.

17. The generator device of claim 16, and further comprising:
a timer electronically connecting the wireless receiver to the electric-to-mechanical transducer.

18. The generator device of claim 17, wherein:
the node further comprises an information inlet in electronic communication with the wireless receiver; and
wherein the timer electronically connects the information inlet of the node to the wireless receiver.

19. The generator device of claim 16, and further comprising a transmitter in electronic communication with an outlet of the node.

20. The generator device of claim 19, wherein the transmitter is a frequency-hopping spread spectrum transmitter, and wherein the wireless receiver is a frequency-hopping spread spectrum receiver.
